(19) United States
(12) Patent Application Publication
(10) Pub. No.: US 2012/0010886 A1
(43) Pub. Date: Jan. 12, 2012

(54) Language Identification

(76) Inventor: Javad Razavilar, San Diego, CA (US)

(21) Appl. No.: 13/177,125

(22) Filed: Jul. 6, 2011

Related U.S. Application Data
(60) Provisional application No. 61/361,684, filed on Jul. 6, 2010.

(51) Int. Cl. G10L 17/00

(52) U.S. Cl. 704/246; 704/E17.001

(57) ABSTRACT

A language identification system suitable for use with voice data transmitted through either a telephonic or computer network systems is presented. Embodiments that automatically select the language to be used based upon the content of the audio data stream are presented. In one embodiment the content of the data stream is supplemented with the context of the audio stream. In another embodiment the language determination is supplemented with preferences set in the communication devices and in yet another embodiment, global position data for each user of the system is used to supplement the automated language determination.

### CROSS-REFERENCE TO RELATED APPLICATIONS

This application claims priority from U.S. provisional application 61/361,684 filed on Jul. 6, 2010 titled “Language Translator” currently pending and by the same inventor.

### BACKGROUND OF THE INVENTION

1. Technical Field

The present invention relates to apparatus and methods for real time language identification.

2. Related Background Art

The unprecedented advances in Internet and wireless systems and their ease of accessibility by many users throughout the world have made telephone and computer systems ubiquitous means of communications between people. Currently the number of wireless mobile users for both voice & data in most of the developing countries in the world is more than fixed landline users. Instant messaging over Internet and voice and Internet services over wireless systems are among the most heavily used applications and generate most of the traffic over Internet and wireless systems.

Communication between speakers of different languages is growing exponentially and the need for instant translation to lower the barriers of different languages has never been greater. A first step in the automated translation of communication is identification of the language being typed or spoken. Currently there are an estimated 6000 languages spoken in the world. However the distribution of the number of speakers for each language has led researchers to develop algorithms that limit automatic translation to the top ten or so languages. Even this is a formidable task. Typical processes for automated determination of a spoken language start by electronically capturing and processing uttered speech to produce a digital audio signal. The signal is then processed to produce a set of vectors characteristic of the speech. In some schemes these are phonemes. A phoneme is a sound segment. Words and sentences in speaking are combinations of phonemes. The occurrence and sequence of phonemes is compared with phoneme-based language models for a selected set of languages to provide a probability for each of the languages in the set that the speech is that particular language. The most probable language is identified as the spoken language. In other processes the vectors are not phonemes but rather other means such as frequency packets parsed from a Fourier transform analysis of the digitized speech waveforms. The common feature of all currently used processes to determine the spoken language is first to accomplish some form of analysis on the speech to define the speech vectors and then to analyze these vectors in a language model to provide a probability for each of the languages for which models are included. Neither the initial analysis nor the language models are independent of the particular languages. The processes typically use a learning process for each language of interest to calibrate both the initial analysis of the speech as well as the language models. The calibration or training of the systems can require hundreds of hours of digitized speech from multiple speakers for each language. The learning process requires anticipating a large vocabulary. Even if done on a today's fastest computers, the analysis process is still too slow to be useful in a real time system. Vector analysis and language models are generally only available for a very limited number of languages. Thus far there are no known systems that can accurately determine which language is being spoken for a significant portion of the languages actually used in the world. There are too many languages, too many words and too many identification opportunities to enable a ubiquitous language identification system. There is a need for a new system that simplifies the problem.

### SUMMARY OF THE INVENTION

A language identification system and process are described that use extrinsic data to simplify the language identification task. The invention makes use of language selection preferences, the context of the speech and location as determined by global positioning or other means to reduce the computational burden and narrow the potential language candidates. The invention makes use of extrinsic knowledge that: 1) a particular communication device is likely to send and receive in a very few limited languages, 2) that the context of a communication session may limit the likely vocabulary that is used and 3) that although there may be over 6000 languages spoken in the world, the geographic distribution of where those languages are spoken is not homogeneous. The preferences, context and location are used as constraints in both the calibration, and training, of the language identification system as well as the real time probabilistic determination of the spoken language. The system is applicable to any device that makes use of spoken language for communication. Exemplary devices include cell phone, land line telephones, portable computing devices and computers. The system is self-improving by using historic corrected language determinations to further the calibration of the system for future language determinations. The system provides a means to improve currently known algorithms for language determination.

In one embodiment the system uses language preferences installed in a communication device to limit the search for the identification of the spoken language to a subset of the potential languages. In another embodiment the identification of the spoken language is limited by the context of the speech situation. In one embodiment the context is defined as the initial conversation of a telephone call and the limitation is on the calibration of the system and limitation on the determination and analysis of phonemes typical of that context. In another embodiment the location of the communication devices is used as a constraint on the likely language candidates based upon historic information of the likelihood of particular languages being spoken using communication devices at that location. In one embodiment the location is determined by satellite global positioning capabilities incorporated into the device. In another embodiment the location is based upon the location of the device as determined by the cellular network.

In another embodiment the invented system is self-correcting and self-learning. In one embodiment a user inputs whether the system has correctly identified the spoken language. If the language is correctly identified the constraints used in that determination are given added weighting in future determinations. If the system failed to correctly identify the spoken language the weighting of likely candidates is adjusted.

### BRIEF DESCRIPTION OF THE DRAWINGS

FIG. 1 is a diagrammatic view of a first embodiment of the invention.

FIG. 2 is a diagrammatic view of a second embodiment of the invention.

FIG. 3 is a diagrammatic view of a third embodiment of the invention.

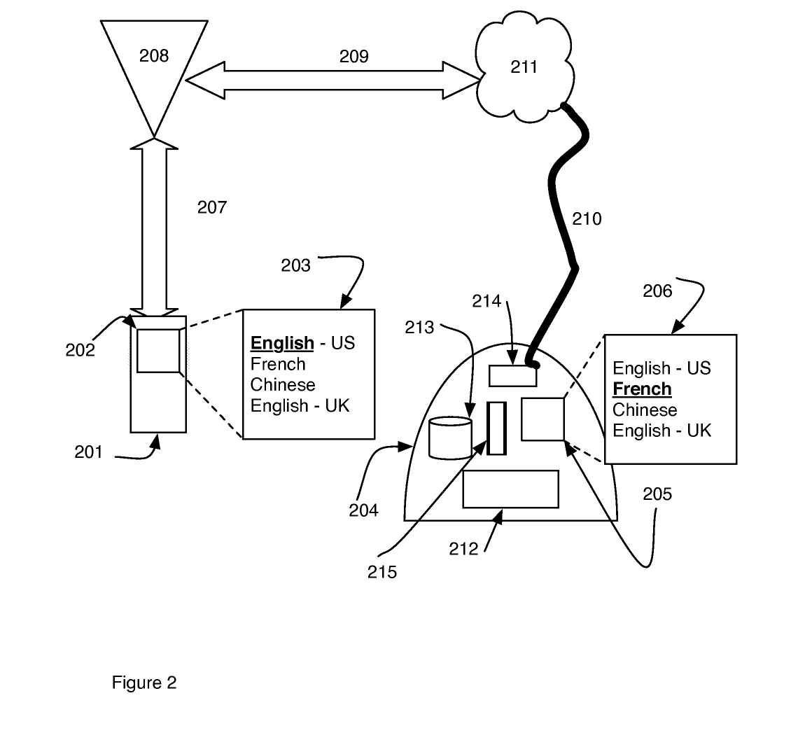

FIG. 2 is a diagrammatic view of a fourth embodiment of the invention.

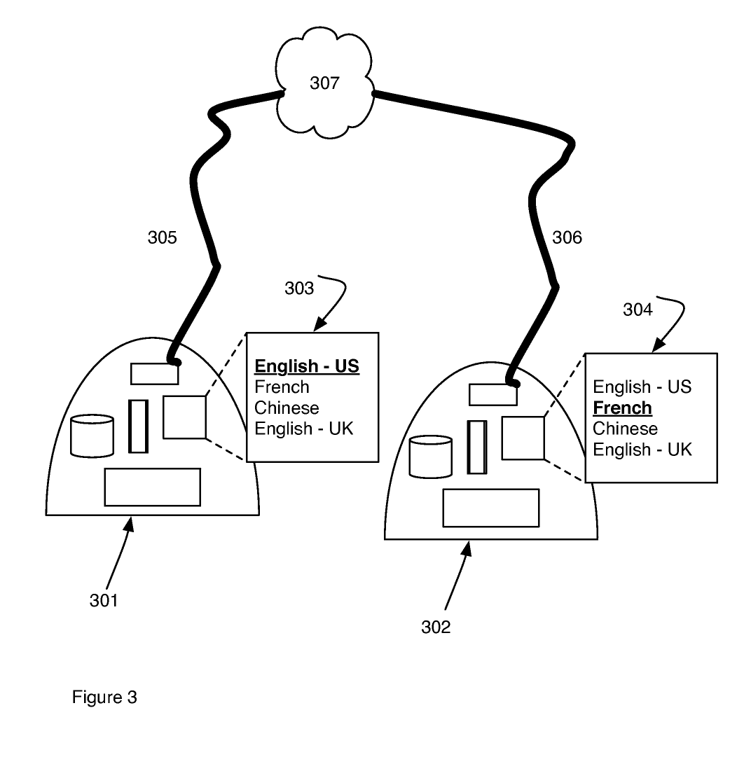

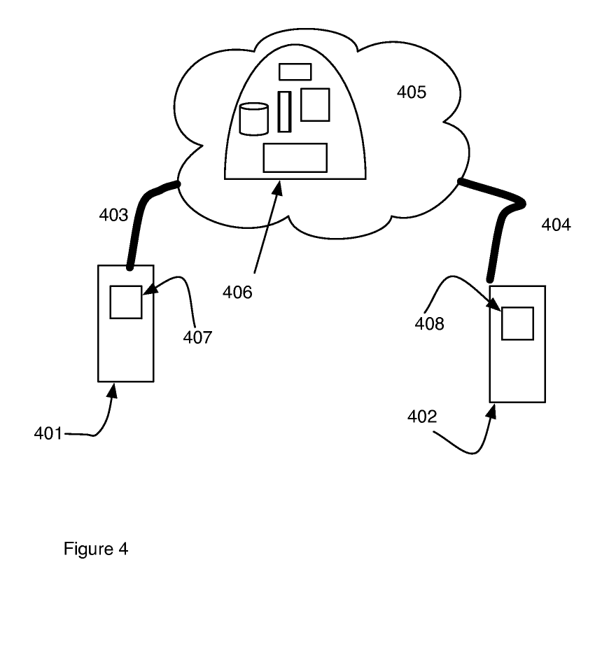

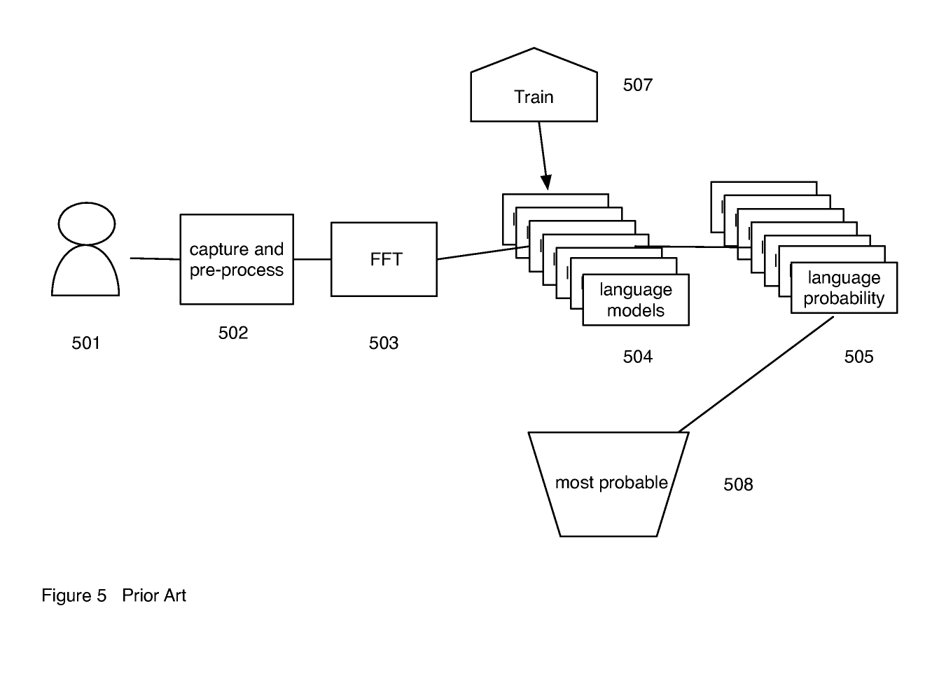

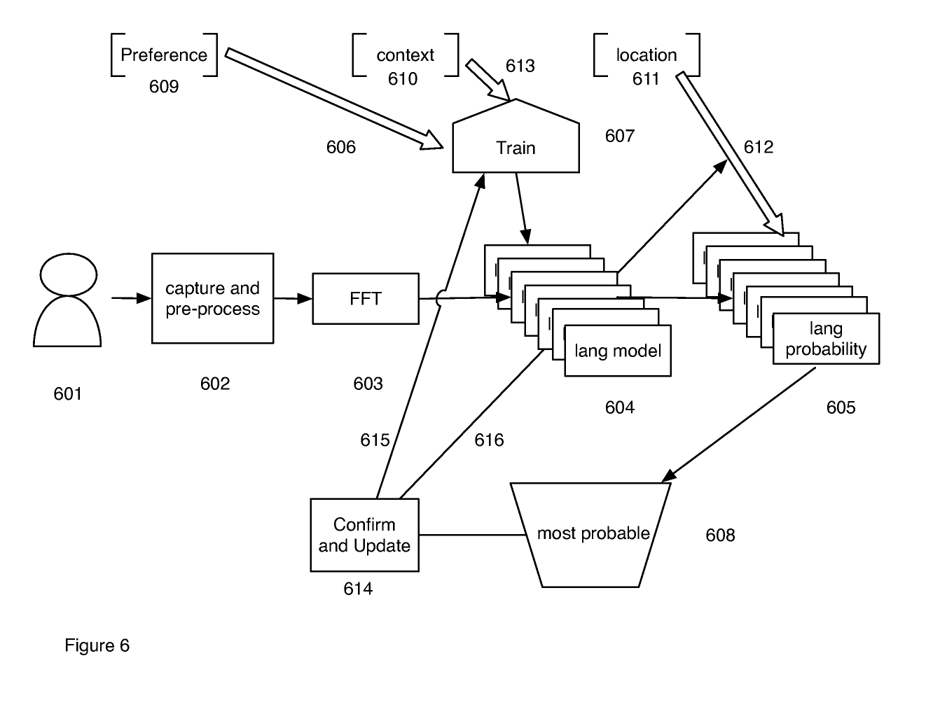

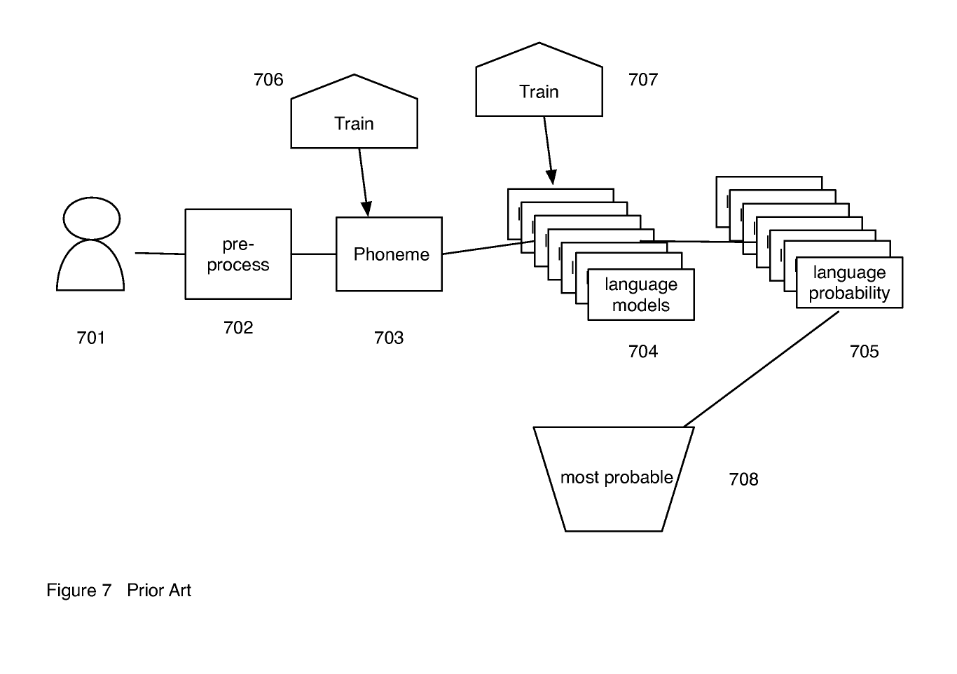

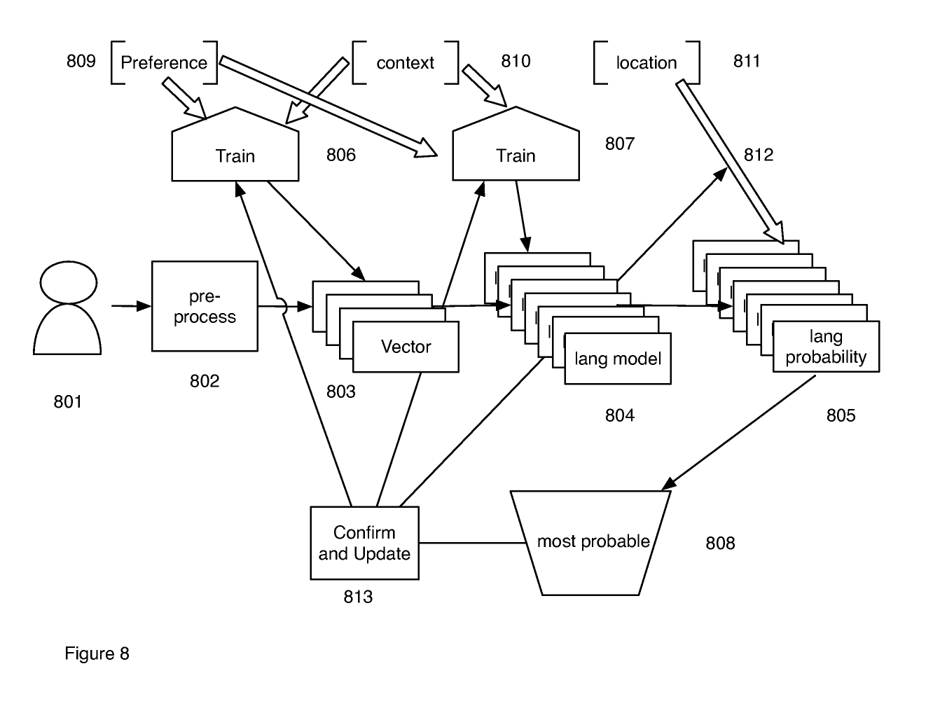

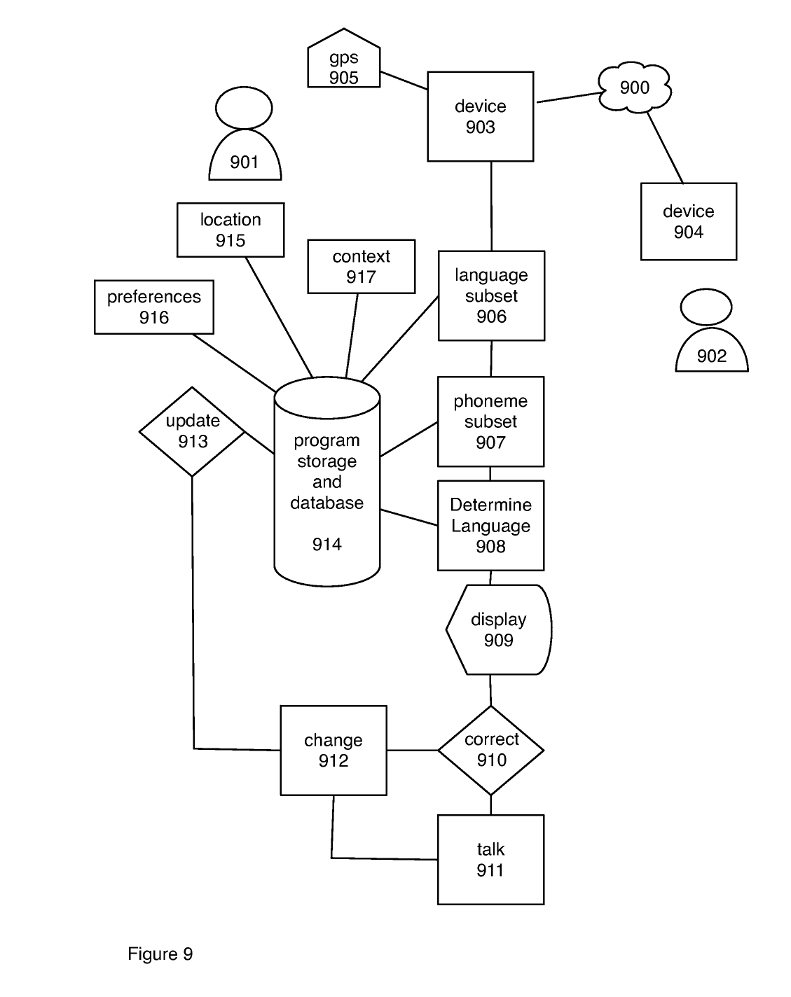

FIG. 3 is a diagrammatic view of a third embodiment of a translator including a global positioning system.

FIG. 5 is a chart showing prior art processes for language determination.

FIG. 6 is a chart showing a first embodiment as improvements to prior art processes for language determination.

FIG. 7 is a chart showing additional prior art processes for language determination.

FIG. 8 is a chart showing embodiments as improvements to prior art processes of FIG. 7.

FIG. 9 is a flow chart applicable to the embodiments of FIGS. 6 and 8.

### DISCLOSURE OF THE INVENTION

The invented systems for language determination include both hardware and processes that include software programs that programmatically control the hardware. The hardware is described first followed by the processes.

### The Hardware

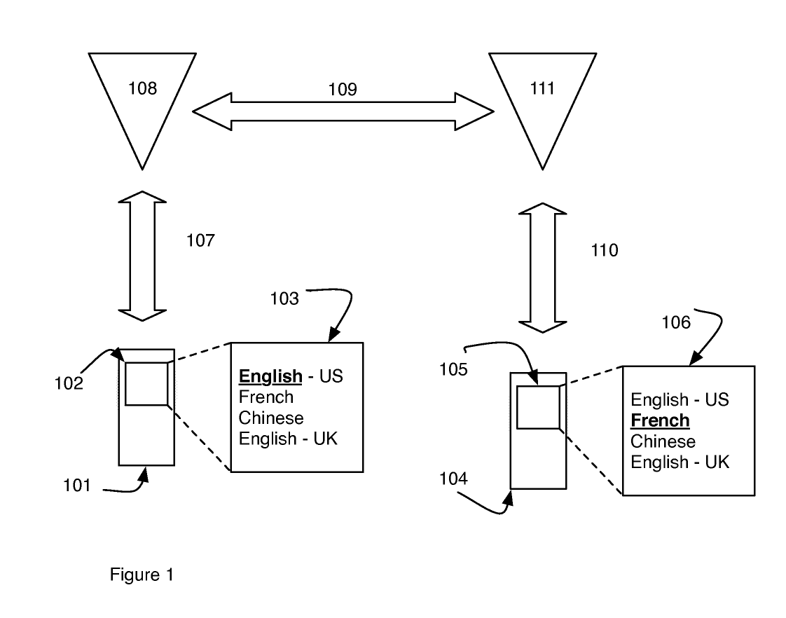

Referring now to FIG. 1 a first embodiment includes a first communication device 101 that includes a process for selecting a preferred language shown on the display 102 as in this case selecting English—US 103. The device is in communication 107 with a communications system 108 that, in turn, communicates 109 with a second communications system 111 that provides a communications 110 with a second communication device 104 that similarly includes means to select and display a preferred language 105, 106. The selected language in the illustrated case 106 is French. Non-limiting exemplary communication devices 101, 104 include cellular telephones, landline telephones, personal computers, wireless devices that are attached to or fit entirely in the ear of the user, and other portable and non-portable electronic devices capable of being used for audio communication. The communication devices 101, 104 can both be the same type device or any combination of the exemplary devices. Non-limiting exemplary communication means 107, 110 include wireless communication such as between cellular telephones, 3G networks, 4G networks, and cellular towers and wired communication such as between land-line telephones and switching centers and combinations of the same. Non-limiting exemplary communication systems 108, 111 include cellular towers, 3G networks, 4G networks, servers on the Internet and servers that enable cellular or landline telephonic or computer data communication. These communication centers are connected 109 by wired or wireless means or combinations thereof. The communication devices 101 and 104 include a means to select the preferred language of communication for both sending or receiving or both. The preferred language may be selected as a single language or as a collection of languages. The example 103 of FIG. 1 shows a case where the likely languages are English—US, French, Chinese and English—UK. The selection indicates that preferences may be set for variations of a single language, e.g. English—US and English—UK as well as settings that reflect a collection of languages e.g. Chinese. In the example shown 103 English is selected as the outgoing language and all listed are selected as likely incoming languages.

FIG. 2 shows devices that are included in additional embodiments of the invention. A communication device 201 with a display 202 and means to select preferred languages 203 communicates through a communication system 208 that is linked 209 to the Internet 211. The first device 201 may communicate in this embodiment to a computing device 204. The computing device includes a user interface 212, a computer processor 215, memory 213 a display 205 and a means such as an interface card 214 to connect to the Internet. The memory 213 stores programs and associated data to be descried later for the automatic determination of the language of a communication from the device 201. The programs stored on the memory 213 include programs that allow selection of most likely languages such as indicated 206 and described earlier. The user interface 212 includes both keyboard entry and ability to input and output audio. The computing device may be a personal computer, a portable computing device such as a tablet or other computing devices with similar components. In one embodiment the computing device 204 is a cellular telephone. In another embodiment both the communication device 201 as well as the computing device 204 are cellular telephones that include the listed components.

In another embodiment the communication devices are depicted as shown in FIG. 3 where communication device 301 is communicating with communication device 302. Components are seen to include the same components as described in conjunction with FIG. 2 The devices are both linked 306 to through a network 307 to one another. The network 307 may be the Internet, a closed network, direct wired connection between devices or other means to link electronic devices for communication as are know in the art.

In yet another embodiment shown in FIG. 4 communication devices 401, 402 are electronically linked 403, 403 through means already discussed to a network 405 that includes the typical networks described above, The devices are further linked in the network through a server and computing device 406. The device 406 includes components as described earlier typical of a computing device. The communication devices in this case may be have minimal computation capabilities and include only user interfaces 407, 408 as required to initiate communication and set preferences. The memory of the computing device 406 further includes programs described below to automatically determine the language communicated from each of the communication devices 401, 402.

It is seen through the embodiments of FIGS. 1-4 that the communication capabilities and required computing capabilities to automatically determine the communicated language may be located within one or both communication devices or in fact neither and be located remotely or any combination of the above. The system includes two devices connected in some fashion to allow communication between the devices and a computing device that includes a program and associated data within its memory to automatically determine the communicated language from one or both connected devices.

### The Processes

Referring now to FIG. 5 a prior art system for determination of the language of an audio communication is shown. Various prior art systems include the common features as discussed below. Exemplary systems know in the art are described in Comparison of Four Approaches to Automated Language Identification of Telephone Speech, Mark A. Zissman, IEEE Transactions of Speech and Audio Processing, Volume 4, No. 1, January, 1996 (IEEE Piscataway, N.J.), which is hereby incorporated in its entirety by reference. The prior art processes shown in FIG. 5 may also be known in the literature as Gaussian mixture models. They rely upon the observation that different languages have different sounds and different sound frequencies. The speech of a speaker 501 is captured by an audio communication device and preprocessed 502. The speech is to be transmitted to a second device not shown as discussed in conjunction with FIGS. 1-4. The objective of the system is to inform the receiving device the language that is spoken by the speaker 501. The preprocessing includes analog to digital conversion and filtering as is known in the art. Preprocessing is followed by analysis schemes to decompose the digitized audio into vectors. In one embodiment the signal is subject to a Fourier Transform analysis producing vectors characteristic of the frequency content of the speech waveforms. These vectors are known in the art as cepstrals. Also included in the FFT analysis is a difference vector of the cepstral vectors defined in sequential time sequences of the audio signal. Such vectors are known in the art as delta cepstrals. In the decomposition using Fourier transform there is no required training for this step. The distribution of cepstrals and delta cepstrals in the audio stream is compared 504 to the cepstral and delta cepstral distributions in known language models. The language models are prepared by capturing and analyzing known speech of known documents through training 507. Training typically involves capturing hundreds of hours of known speech such that the language model includes a robust vocabulary. By comparison of the captured and vectorized audio stream with the library of language models a probability 505 for each language within library of trained languages is determined. That language with the highest probability is the most probably 508 and the determined language. Depending upon the quality of the incoming audio stream and the extent of the training errors of 2 to 10% are typical. This error rate is for cases where the actual language of the audio stream is in fact within the library of languages in the language models. The detailed mathematics are included in the Zissman reference cited above and incorporated by reference.

The math can be summarized by equation 1:

$$\hat{l} = argmax {\sum }_{t = 1}^{t = T} [ log p ( {{x}_{t}}^{} \vert {λ}_{t}^{C} ) + log p ( {{y}_{t}}^{} \vert {λ}_{t}^{DC} ) ] \qquad ( 1 )$$

### Where

\hat{l} is the best estimate of the spoken language in the audio stream
xₜ and yₜ are the cepstral and delta cepstral vectors respectively from the fourier analysis of the audio stream
λₜ^{C} and λₜ^{DC} are the cepstral and delta cepstral values for the Gaussian model of the language defined through the training procedure and the p's are probability operators.

The summation is over all time segments within the captured audio stream of having a total length of time T.

Referring now to FIG. 6 an embodiment of an improvement to the prior art of FIG. 5 is shown. A speaker 601 audio stream is captured and preprocessed 602 and the audio stream from the speaker is decomposed into vectors through a Fourier transform analysis 603. The probability of the audio stream from the speaker being representative of a particular language is obtained using the probability mathematics as described above. An audio communication by its nature includes a pair of communication devices. The recipient of the communication is not depicted in FIGS. 5-10 but it should be understood that there is both a sender and a receiver of the communication. The objective of the system is to identify to the recipient the language being spoken by the sender. Naturally in a typical conversation the recipient and sender continuously exchange roles as a conversation progresses. As discussed in conjunction with FIGS. 1-4, the hardware and the algorithms of the language determination may be physically located on the communication device used by the speaker, on a communication device used by the recipient or both or on a computing device located intermediary between the speaker and the recipient. It should be clear to the reader that the issue and solutions presented here apply in both directions of communication and that the hardware and processes described can equally well be distributed or local systems. In one embodiment the training and/or the calculation of the most probable language are now supplemented as indicated by the arrows 606, 612, 613 by preferences 609, context 610 and location 611. The supplementation by these parameters simplify and accelerate the determination of the most probable language 608. Non-limiting examples of preferences are settings included in the communication device(s) indicating that the device(s) is (are) used for a limited number of languages. As indicated the preferences may be located in the sending device in that the sender is likely to speak in a limited number of languages or in the receiving communication device where the recipient may limit the languages that are likely to be spoken by people who call the recipient. The preference supplement information 606 then would limit or filter the number of languages where training 607 is required for the language models 604. The language models contained in the database of the language identification system would be filtered by the preference settings to produce a reduced set and speed the computation. The preference information would also reduce or filter the number of language models 604 included in the calculation of language probabilities 605. In terms of the calculation summarized in equation 1 the supplemented information of preferences would limit or filter the number of Gaussian language models for which the summation of probabilities and maximum probability is determined. The preferences are set at either the sender audio communication device or the receiver audio communication device or both. In one embodiment the preferences are set as a one-time data transfer when the communication devices are first linked. In another embodiment the preferences are sent as part of the audio signal packets sent during the audio communication.

In another embodiment the language identification is supplemented by the context of the audio communication. The first minute of a conversation regardless of the language uses certain limited vocabulary. A typical conversation begins with the first word of hello or the equivalent. In any given language other typical phrases of the first minute of a phone conversation include:

### Hello

### How are you

### Where are you

### What is new

How can I help you?
This is [name]
Can I have [name]
speaking
is [name] in?
Can I take a message?

The context of the first minute of a conversation uses common words to establish who is calling, whom are they calling and for what purpose. This is true regardless of the language being used. The context of the conversation provides a limit on the vocabulary and thereby simplifies the automated language. The training required of language models therefore if supplemented by context results in a reduced training burden. The language models are filtered by the context of the conversation. The vocabulary used in the training is filtered by the context of the conversation. The language models no longer need an extensive vocabulary. In term of the model discussed in conjunction with FIGS. 5 and 6 analysis of a reduced vocabulary results in a reduction of the unique cepstral and delta cepstral vectors included in the Gaussian model. In terms of equation 1, there are a limited number of λₜ^{C}'s and λₜ^{DC}'s over which probabilities are determined. Context information supplementing the language identification simplifies and accelerates the process by filtering the λₜ^{C}'s and λₜ^{DC}'s to those relevant to the context. In another embodiment the context of the conversation is an interview where a limited number of responses can be expected. In another embodiment the context of the conversation is an emergency situation such as might be expected in calls into a 911 emergency line.

Limitations based upon the context of a conversation such the limited first portion of a telephone conversation supplement and accelerate the process by another means as well. It is seen in equation 1 that the calculation of language identification probabilities is a summation of probabilities factors over all time packets from the first t=1 to the time limit of the audio t=T. The context supplement to the audio identification places an upper limit on T. The calculation is shortened to just the time of relevant context. The time over which the analysis takes placed is filtered by the time that is relevant to the context. In the embodiment of the introduction to a telephone conversation, time beyond the first minute of a conversation the context and associated vocabulary shifts from establishing who is speaking and what do they want to the substance of the conversation which requires an extended vocabulary. Therefore in this embodiment the summation is over the time from the initiation of the call to approximately one minute into the call. The time is filtered to the first minute of the call.

In another embodiment, also illustrated in FIG. 6 the language identification is further supplemented by location 611 of the sending communication device. In one embodiment location is determined by the electronic functionality built into the communication device. If the device is a cellular telephone or many portable electronic devices location of the device is determined by built in global positioning satellite capabilities. In another embodiment location is determined by triangulation between cellular towers as is known in the art. In another embodiment, location is manually input by the user. The location of a device is correlated with the likelihood of the language being spoken by the user of the device. The database of the language identification system includes this correlation. In a trivial example if the sending communication device is located in the United States the language is more likely to be English or Spanish. In another embodiment the location and the correlation of probability of the language being spoken and location is specific to cities and neighborhoods within a city. The location information supplements the language by encoding within the algorithm a weighting of the likely language to be spoken by the sending device. The probable languages are filtered on the basis of the location of the device and the correlation of locations and languages spoken in given locations. The encoding may be in the device of the sender, the device of the receiving communication device or in a computing device intermediary between the two. In the latter two cases the sending device sends a signal indicating the location of the sending device. The language determination algorithm then includes a database of likely languages to be spoken using a device at that location. The database may be generated by known language determinations from census and other data. In another embodiment discussed below the database is constructed or supplemented by corrections based upon results of actual language determinations. The value of the location information supplement is to limit the number of language models 604 that need to be included in the probability calculations of Equation 1, thereby accelerating the determination of the spoken language. In another embodiment the language probabilities 605 as determined using the calculation of Equation 1 are further weighted or filtered by the likelihood of those languages being spoken for a sending communication device at the location of the sending communication device. Thereby influencing the most probably language 608 as determined by the algorithm.

In another embodiment the determination of the language spoken by the sending device is confirmed 614 by one or both users of the communication devices in contact. The confirmation information is then used to feed back 615 to the training and to the location influence 616 to update the training of which language models should be included in the calculation of the most probable language determination and to adjust the weighting in the database of language probability and location.

Supplementing the determination of the spoken language in an audio stream is not dependent upon the algorithm described in FIG. 5 and Equation 1. FIG. 7 shows block diagrams of additional common prior art methods used to identify the language being spoken in an audio conversation. Details of the algorithms are described in the Zissman reference identified earlier and incorporated in this document by reference. In these additional schemes a user 701 speaks into a device that captures and pre-processes 702 the audio stream. The audio stream is then analyzed or decomposed 703 to determine the occurrence of phonemes or other fundamental audio segments that are known in the art as being the audio building blocks of spoken words and sentences. The decomposition into phonemes is done by comparison of the live audio stream with previous learned audio streams 706 through training procedures known in the art and described in the Zissman reference. The procedures as depicted are known in the art as “phone recognition followed by language modeling” or PRLM. A similar language recognition model uses a parallel process in which phonemes for each language are analyzed in parallel followed by language modeling for each parallel path. Such models are known in the art as parallel PRLM processes. Similarly there are language identification models that use a single vectorization step followed by parallel language model analysis or decomposition, such models are termed Parallel Phone recognition. There are other more recent publications such as those described in the article by Haizhou Li, “A Vector Space Modeling Approach to Spoken Language Identification”, IEEE Transactions on Audio, Speech, and Language Processing, Volume 15, No. 1, January 2007, (IEEE Piscataway, N.J.), which is incorporated by reference herein in its entirety, which describes new vectorization techniques followed by language model analysis. The common features of the prior art language identification techniques include a vectorization or decomposition process that in some cases rely on a purely mathematical calculation without reference to any particular language and in some cases rely on vectorization specific to each language wherein the vectorization requires “training” in each language of interest prior to analysis of an audio stream. It is seen that the inventive steps described herein are applicable to the multitude of language identification processes and will provide improvements through simplification of the processes and concomitant speed improvements through reduction of the computational burden. In some cases the training 706 and the determination 703 of the phonemes contained in the audio stream is specific to particular languages. In some cases the analysis 703 parses the language into other vector quantities not technically the same as phonemes. The embodiments of this invention apply equally well to those schemes that are more generically described below in conjunction with FIG. 9. Once the language has been analyzed 703 or decomposed into the vector components, be they phonemes or others, the occurrence, distribution and relative sequence of phonemes is fit to language models 704. The language models are built through training procedures 707 known in the art by capturing and analyzing known language audio streams and determining the phoneme distribution, sequencing and other factors therein. The comparison of the audio stream with the language models produces a probability 705 for each language included in the language models of the algorithm database that the selected language is in fact the language of the audio stream. That language with the highest probability 708 is identified as the language of the audio stream.

Referring now to FIG. 8, embodiments of the invention that represent improvements to the prior art general schemes for language identification described in FIG. 7 are shown. The process for language identification is supplemented by preferences 809, context 810 and location 811. Embodiments of the invention may include one or any combination of all these supplementary factor information. A user 801 speaks into a communication device that captures and preprocesses the audio stream 802. The audio stream is then decomposed into vectors 803 through processes known in the art. The vectors may be phonemes, language specific phonemes or other vectors that break the spoken audio stream down into fundamental components. The decomposition analysis process 803 is defined by a learning process 806 that in many cases is specific to each language for which identification is desired. The vectorized audio stream is then compared to language models 804 to provide a probability 805 for each of the languages included in the process. The comparison is by means known in the art including occurrence of particular of particular vector distributions and occurrence of particular sequences of vectors. Ranking of the language probabilities produces a most probable 808 language selection. The language is identified as that languages that is most probable based upon the vectorization and language models included in the analysis procedure.

In one embodiment the training 806 of the vectorization process and the training 807 of the language models are supplemented by preferences 809 that are set in the communication device of the sender of the audio communication stream. In one embodiment the preferences are a limited set of languages that are likely to be spoken into the particular communication device. In another embodiment the preferences are set in the communication device of the recipient of the audio stream and the preferences are those languages that the recipient device is likely to receive. In one embodiment the information of language preferences is used to restrict the number of different languages for which the vectorization process is trained. Thereby simplify the language identification and speeding the process. In another embodiment the preferences limit the number of language models 804 included in the language identification process. Thereby simplify the language identification and speeding the process. Limiting the languages included in the training of the language identification system or limiting the languages included in the probability calculations is another means of stating the database for the training process and the probability calculation is filtered by the preference settings prior to the actual calculation of language probabilities and determining the most likely language being spoken in the input audio stream. The filtering may take place at early stages where the system is being defined or at later stages during use. In another embodiment the preference filtering may be in anticipation of travel where particular languages are added or removed from the preference settings. The database would then be filtered in anticipation of detecting languages within the preferred language set by adding to or removing language models as appropriate.

In another embodiment the language identification process is supplemented by the context 810 of the conversation. In one embodiment the context information includes limitations in the vocabulary and time of the introduction to a telephone call. In one embodiment the context information is used to supplement the training 806 of the vectorization process. The supplement may limit the number of different vectors that are likely to occur in the defined context. In another embodiment the context information is used to supplement the training 807 of the language models 804. The supplement may be used to limit the number of different vectors and the sequences that are likely to occur in each particular language when applied to the context of the sent audio stream communication. These limits imply a filtering of data both in the training process to limit the vocabulary as well as a filtering during the sue of the system through a time and vocabulary filter.

In another embodiment the location of the sending device 811 is used to supplement 812 the language identification process. In one embodiment the location of the sending device is used to define a weighting for each language included in the process. The weighting is a probability that the audio stream input to a sending communication device at a particular location would include each particular language within the identification process.

In another embodiment the accuracy of the language identification is confirmed 813 by the users of eh system. The confirmation is then used to update the process as to the use of the preferences, context and location. In one embodiment the update indicates the need to add another language to the vectorization and language models. In another embodiment the update includes changing the probabilities for each spoken language based upon location.

Referring now to FIG. 9 a flow chart and system diagram for process embodiments of the present invention are shown. A user 901 communicates into a communication device 903 that is connected 900 to a second user 902 communication through a second communication device 904. The details as further described with reference to just the first user who is both a sender and a receiver of audio communication. It is to be understood that the device features and processes may be in use by both the first user 901 and the second user 902 or by just one of the two users. The location of the device 903 is determined 905 by either GPS as shown or other means such as triangulation with cellular towers or input by the user, or preset for a fixed device. The system includes storage capabilities 914 that contain algorithms and database required for the computing device that effects the steps in the language identification process here described. The database and the program steps are filtered by the settings of the preferences 916, location 915 and context 917. The location information 915 feeds into a language subset 906 that includes language models for the languages that are potential identification candidates. The particular language candidates and language models for each of the language candidates are stored on the storage device 914. In one embodiment the device location 915 is used to programmatically select 906 a subset of the languages likely to be spoken into the device at that particular location. In another embodiment the limitations of location further leads to a limitations of the phoneme subset 907 again programmatically selected form all phoneme sets stored in the storage location 914. It is understood that the phoneme set may be more generically referred to as vectors of the audio stream from sending user as has already been discussed and exemplified. An algorithm also contained in the storage 914 is used to determine the most probably language 908 being spoken by the sender. In one embodiment the algorithm further use as input the context of the audio stream 917. Context and its method of use have been described above. In another embodiment preferences 916 set in the storage 914 are further used as supplemental input to the algorithms of the language identification process. Again the nature of preferences and their use have both already been disclosed. A most probable language is determined 908 and displayed to the users 909. Display may include a visual display on the display of a communication device or display may include audio communication of the most probable language to the users. In one embodiment the user may then confirm or deny 910 the correctness of the identified language. And if confirmed continue the conversation 911. In another embodiment the user may change the selected language 912 if the wrong language has been identified. In another embodiment the results of the language identification are used to update 913 the algorithms and database including filter settings held within the storage 914 such that future language identification steps may make use of the accuracy or lack thereof of the past language identification sessions. The steps and features represent features that may be selectively included in the invented improved language identification system and process. It should be understood that a subset of the identified system devices and processes may also lead to significant improvements in the process and such subsets are included in the disclosed and claimed invention.

### SUMMARY

A language identification system suitable for use with voice data transmitted through either a telephonic or computer network systems is presented. Embodiments that automatically select the language to be used based upon the content of the audio data stream are presented. In one embodiment the content of the data stream is supplemented with the context of the audio stream. In another embodiment the language determination is supplemented with preferences set in the communication devices and in yet another embodiment, global position data for each user of the system is used to supplement the automated language determination.

While the present invention has been described in conjunction with preferred embodiments, those of ordinary skill in the art will recognize that modifications and variations may be implemented. Supplementing all language identification processes having the common features of capture, vectorization and language model analysis to produce a most probable language can be seen to benefit from the invention presented. The present disclosure and the claims presented are intended to encompass all such systems

What is claimed is:

1. A language identification system comprising:
a) a first electronic communication device and a second communication device each of the said communication devices having a user and each communication device including a means for accepting a spoken audio input from the user and converting said input into an electronic signal, an electronic connection to transmit said electronic signals between the communication devices, the spoken audio inputs each having a language being spoken, a location where the spoken audio input is spoken, and a context,
b) a computing device including memory, said memory containing a language identification database and encoded program steps to control the computing device to:
i) decompose the audio input into vector components, and,
ii) compare the vector components to a database of stored vector components of a plurality of known languages, thereby calculating for each language a probability that the language of the spoken audio input is the known language, and,
iii) select from the known language probabilities that with the highest probability thereby identifying the most probable language as the language being spoken in the spoken audio input,
c) where the encoded program steps accept as a supplemental input at least one of:
i) a set of language preferences selected by at least one of the users of the communication devices,
ii) the location of at least one of the communication devices, and,
iii) the context of the spoken audio inputs into the communication devices,
d) where said database of stored vector components further includes filters wherein the supplemental input is used to filter the plurality of known languages, and
e) where said encoded program steps further include a step for the users to confirm or deny the most probable language as the language being spoken updating the filters based upon the said step for the users to confirm or deny.

2. The language identification system of claim 1 where the supplemental input is context and where the context is the initial time of the audio inputs and the users are establishing their identity and a reason for the spoken audio inputs.

3. The language identification system of claim 1 where the supplemental input is context and the context is a set of survey questions.

4. The language identification system of claim 1 where the supplemental input is context and the context is a request for emergency assistance,

5. The language identification system of claim 1 where the supplemental input is the language preference.

6. The language identification system of claim 1 where the supplemental input is the location of at least one of the communication devices.

7. The language identification system of claim 1 where the communication devices are cellular telephones.

8. The language identification system of claim 1 where the communication devices are personal computers.

9. The language identification system of claim 1 where the computing device is located separate from the communication devices.

10. A language identification process said process comprising:
a) accepting spoken audio inputs from users of a first electronic communication device and a second communication device and converting said input into electronic signals, and transmitting said electronic signals between the communication devices, the spoken audio inputs each having a language being spoken, a location where the spoken audio input is spoken, and a context,
b) decomposing the audio input into vector components and
c) comparing the vector components to a database of stored vector components of a plurality of known languages, thereby calculating for each language a probability that the language of the spoken audio input is the known language and
d) selecting from the known language probabilities that with the highest probability and thereby identifying the most probable language as the language being spoken in the spoken audio input, and,
e) accepting as a supplemental input at least one of:
i) a set of language preferences selected by at lest one of the users of the communication devices,
ii) the location of at least one of the communication devices, and,
iii) the context of the spoken audio inputs into the communication devices,
f) and filtering the plurality of known languages based upon the supplemental input and filters in the database,
g) and confirming that the most probable language is in fact the language being spoken and updating the filters in the database.

11. The language identification process of claim 10 where the supplemental input is context and where the context is the initial time of the audio inputs and the users are establishing their identity and a reason for the spoken audio inputs.

12. The language identification process of claim 10 where the supplemental input is context and the context is a set of survey questions.

13. The language identification system of claim 1 where the supplemental input is context and the context is a request for emergency assistance.

14. The language identification process of claim 10 where the supplemental input is the language preference.

15. The language identification process of claim 10 where the supplemental input is the location of at least one of the communication devices.

16. The language identification process of claim 10 where the communication devices are cellular telephones.

17. The language identification process of claim 10 where the communication devices are personal computers.

18. The language identification process of claim 10 where at least one of the decomposing the audio input, comparing the vector components, and, selecting from the known language probabilities, is done on a computing device located remotely from the communication devices.
